(19) United States
(12) Patent Application Publication
(10) Pub. No.: US 2026/0343241 A1
(43) Pub. Date: Oct. 29, 2026

(54) METHOD, DEVICE, AND MEDIUM FOR CONFIGURATION ERROR MANAGEMENT WITH SUBSCRIBER PRIVACY SERVICE

(71) Applicant: Verizon Patent and Licensing Inc., Basking Ridge, NJ (US)

(72) Inventors: Yousif Targali, Sammamish, WA (US); Vinod Kumar Choyi, Conshohocken, PA (US)

(21) Appl. No.: 19/189,412

(22) Filed: Apr. 25, 2025

(51) Int. Cl. H04W 12/72; H04W 12/02; H04W 12/75

(52) U.S. Cl. CPC H04W 12/72; H04W 12/02; H04W 12/75

(57) ABSTRACT

A method, a device, and a non-transitory computer-readable storage medium are described in relation to a configuration error management with subscriber privacy service. The configuration error management with subscriber privacy service may enable a device to obtain a Subscriber Concealed Identifier (SUCI) when the device is unable to generate the SUCI based on software, hardware, and/or information failures. The device may provide a network with an error code pertaining to a failed attempt to generate the SUCI. The device may provide the network with a temporary identifier of a device user or a home network key. The device may update SUCI parameters. The device may inform the user of the error generated and may assist in the recovery when the device is unable to connect with the network and report the error condition.

### BACKGROUND

Development and design of networks present certain challenges from a network-side perspective and an end device perspective. For example, an end device that suffers from a configuration error may cause numerous difficulties in the network and at the end device before such error is resolved.

### BRIEF DESCRIPTION OF THE DRAWINGS

FIG. 1 is a diagram illustrating an exemplary environment in which an exemplary embodiment of a configuration error management with subscriber privacy service may be implemented;

FIGS. 2A and 2B are diagram illustrating an exemplary process of an exemplary of the configuration error management with subscriber privacy service;

FIGS. 3A and 3B are diagrams illustrating another exemplary process of an exemplary embodiment of the configuration error management with subscriber privacy service;

FIGS. 4A and 4B are diagrams illustrating yet another exemplary process of an exemplary embodiment of the configuration error management with subscriber privacy service;

FIGS. 5A and 5B are diagrams illustrating still another exemplary process of an exemplary embodiment of the configuration error management with subscriber privacy service;

FIG. 6 is a diagram illustrating exemplary components of a device that may correspond to one or more of the devices illustrated and described herein;

FIG. 7 is a flow diagram illustrating an exemplary process of an exemplary embodiment of the configuration error management with subscriber privacy service; and

FIG. 8 is a flow diagram illustrating another exemplary process of an exemplary embodiment of the configuration error management with subscriber privacy service.

### DETAILED DESCRIPTION

The following detailed description refers to the accompanying drawings. The same reference numbers in different drawings may identify the same or similar elements. Also, the following detailed description does not limit the invention.

To enable privacy in a Fifth Generation (5G) network, several parameters are needed to be pre-provisioned in a card, such as a Universal Integrated Circuit Card (UICC) to allow the calculation of a Subscriber Concealed Identifier (SUCI) from the Subscriber Permanent Identifier (SUPI), for example. The parameters include the SUPI, a Routing Indicator (RI), a Protection Scheme Identifier, a Home Network Public Key (HNPK), and an HNPK identifier. According to a network standard set forth by a network standardizing body, such as Third Generation Partnership Project (3GPP), 3GPP2, International Telecommunication Union (ITU), European Telecommunications Standards Institute (ETSI), and GSM Association (GSMA), a network operator (or the like), which decides to enable a 5G privacy feature, may allow a null scheme access (i.e., the SUCI may be sent without privacy protection) only in certain cases or under certain conditions. For example, the cases include if the user equipment (UE) is making an unauthenticated emergency session and the UE does not have a 5G Globally Unique Temporary Identifier (GUTI) to the chosen public land mobile network (PLMN), if the home network has configured the “null scheme” to be used, or if the home network has not provisioned a public key needed to generate the SUCI.

A configuration error in the UICC (or another type of card), at the end device (e.g., a UE or the like), or both may occur if the above conditions are not met. For example, if certain information is not correctly provisioned (e.g., incomplete information is provided, a technical mechanism to provision the information has a failure, etc.), the provisioned information is inconsistent (e.g., a mismatched Home Network Public Key size, an invalid protection scheme identifier, etc.), or there is a hardware failure, etc., an error may occur. As a result of the configuration error, the end device or the card may be unable to calculate the SUCI, and because none of the conditions that allow fallback to the “null scheme” are fulfilled, the end device may be in an undefined state. Consequently, the end device may be disconnected from the 5G network without a way to troubleshoot and remedy the error.

According to exemplary embodiments, a configuration error management with subscriber privacy service is described. According to an exemplary embodiment, the configuration error management with subscriber privacy service may include addressing SUCI configuration errors. According to various exemplary embodiments, the configuration error management with subscriber privacy service may include use of operator master shared key-based protection, operator public privacy key-based protection, fallback to a legacy network, using previously un-used identifiers, using previously used identifiers, and using an enhanced null scheme procedure, as described herein.

According to an exemplary embodiment, the configuration error management with subscriber privacy service may include detecting the configuration error for SUCI calculation. According to an exemplary embodiment, the configuration error management with subscriber privacy service may include providing secure transmission of the configuration error from an end device to a network. According to an exemplary embodiment, the configuration error management with subscriber privacy service may perform appropriate actions based on operator policies and customer agreements.

In view of the foregoing, the configuration error management with subscriber privacy service may provide various solutions for managing configuration errors without impacting subscriber privacy, causing disruption of wireless connectivity, and preventing access to application services.

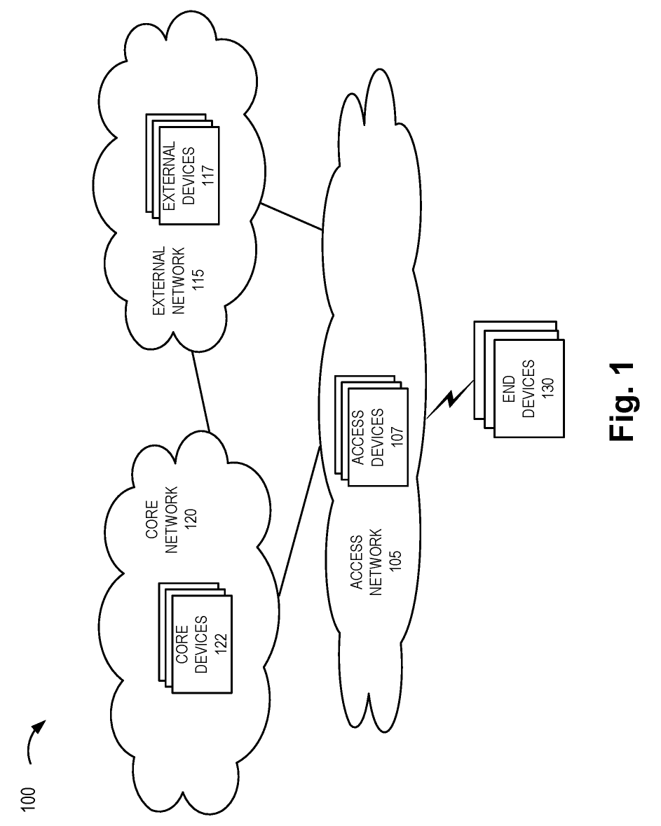

FIG. 1 is a diagram illustrating an exemplary environment 100 in which an exemplary embodiment of the configuration error management with subscriber privacy service may be implemented. As illustrated, environment 100 includes an access network 105, an external network 115, and a core network 120. Access network 105 includes access devices 107 (also referred to individually or generally as access device 107). External network 115 includes external devices 117 (also referred to individually or generally as external device 117). Core network 120 includes core devices 122 (also referred to individually or generally as core device 122). Environment 100 further includes end devices 130 (also referred to individually or generally as end device 130).

The number, type, and arrangement of networks illustrated in environment 100 are exemplary. For example, according to other exemplary embodiments, environment 100 may include fewer networks, additional networks, and/or different networks. For example, according to other exemplary embodiments, other networks not illustrated in FIG. 1 may be included, such as an X-haul network (e.g., backhaul, mid-haul, fronthaul, etc.), a transport network (e.g., Signaling System No. 7 (SS7), an optical network, a wired network, etc.), a time-sensitive network (TSN) system, a deterministic networking (DetNet) network, or another type of network that may support a wireless service and/or an application service, as described herein.

A network device, a network element (NE), or a network function (NF) (referred to herein simply as a network device) may be implemented according to one or multiple network architectures, such as a client device, a server device, a peer device, a proxy device, a cloud device, and/or a virtualized network device. Additionally, a network device may be implemented according to various computing architectures, such as centralized, distributed, cloud (e.g., elastic, public, private, etc.), edge, fog, and/or another type of computing architecture, and may be incorporated into distinct types of network architectures (e.g., Software Defined Networking (SDN), virtual, logical, etc.), as well as used to support other types of network elements (e.g., network slices, quality of service (QoS) flows, packet data unit (PDU) sessions, channels, network paths, tunnels, etc.). The number, the type, and the arrangement of network devices are exemplary.

Environment 100 includes communication links between the networks and between the network devices. Environment 100 may be implemented to include wired, optical, and/or wireless communication links. A communicative connection via a communication link may be direct or indirect. For example, an indirect communicative connection may involve an intermediary device and/or an intermediary network not illustrated in FIG. 1. A direct communication connection may not involve an intermediary device and/or an intermediary network. The number, type, and arrangement of communication links illustrated in environment 100 are exemplary.

Environment 100 may include various planes of communication including, for example, a control plane, a user plane, a service plane, a network management plane, an artificial intelligence and/or a machine learning (AI/ML) (control) plane, and a future generation plane, or a subset thereof. Environment 100 may include other types of planes of communication. A message communicated in support of the configuration error management with subscriber privacy service may use at least one of these planes. For example, the message of an exemplary embodiment of configuration error management with subscriber privacy service may use the control plane. According to various exemplary implementations, the interface of the network device may be a service-based interface (SBI), a reference point-based interface, an Open Radio Access Network (O-RAN) interface, a 5G interface, another generation of interface (e.g., 5G Advanced, 6G, 7G, 4G, etc.), or some other type of network interface (e.g., proprietary, etc.).

Access network 105 may include one or multiple networks of one or multiple types and technologies. For example, access network 105 may be implemented to include a terrestrial network, a non-terrestrial network (e.g., a satellite network, an air-based network, etc.), or a combination thereof. By way of further example, access network 105 may include a 5G RAN, a future generation RAN (e.g., a 6G RAN, a 7G RAN, or a subsequent generation RAN), a centralized-RAN (C-RAN), an O-RAN, and/or another type of access network. Access network 105 may include a legacy RAN (e.g., a Third Generation (3G) RAN, a 4G or 4.5 RAN (Long Term Evolution (LTE) Advanced (LTE-A), LTE Advanced Pro (LTE-A Pro), etc.). Access network 105 may communicate with and/or include other types of access networks, such as, for example, a Wi-Fi® network, a local area network (LAN), a Citizens Broadband Radio System (CBRS) network, a cloud RAN, an O-RAN, a virtualized RAN (vRAN), a self-organizing network (SON), a wired network (e.g., optical, cable, etc.), or another type of network that provides access to or can be used as an on-ramp to access network 105.

Depending on the implementation, access network 105 may include one or multiple types of network devices, such as access devices 107. For example, access device 107 may include a next generation Node B (gNB), an enhanced LTE (eLTE) evolved Node B (eNB), an eNB, a radio network controller (RNC), a radio intelligent controller (RIC), a base station (BS), a base station controller (BSC), a remote radio head (RRH), a baseband unit (BBU), a radio unit (RU), a remote radio unit (RRU), a centralized unit (CU), a CU-control plane (CP), a CU-user plane (UP), a distributed unit (DU), a small cell node (e.g., a picocell device, a femtocell device, a microcell device, a home eNB, a home gNB, etc.), an open network device (e.g., O-RAN Centralized Unit (O-CU), O-RAN Distributed Unit (O-DU), O-RAN next generation Node B (O-gNB), O-RAN evolved Node B (O-eNB)), a 5G ultra-wide band (UWB) node, a future generation wireless access device (e.g., a 5G advanced wireless station, a 6G wireless station, a 7G wireless station, or another generation of wireless station), or another type of cellular wireless station. Access devices 107 may also include a network device that provides a transport service (e.g., routing and forwarding), such as a router, a switch, or another type of layer 3 (e.g., network layer of the Open Systems Interconnection (OSI) model) network device.

According to some exemplary implementations, access device 107 may include a combined functionality of multiple radio access technologies (RATs) (e.g., 4G and 5G functionality, 5G and 5G Advanced functionality, 5G and 6G), etc.) via soft and hard bonding based on demands and needs. According to some exemplary implementations, access device 107 may include a split access device (e.g., a CU-control plane (CP), a CU-user plane (UP), etc.) or an integrated functionality, such as a CU-CP and a CU-UP, or other integrations of split RAN nodes. Access device 107 may be an indoor device or an outdoor device.

External network 115 may include one or multiple networks of one or multiple types and technologies that provide an application service. For example, external network 115 may be implemented using one or multiple technologies including, for example, network function virtualization (NFV), software defined networking (SDN), cloud computing, Infrastructure-as-a-Service (IaaS), Platform-as-a-Service (PaaS), Software-as-a-Service (SaaS), or another type of network technology. External network 115 may be implemented to include a cloud network, a private network, a public network, a multi-access edge computing (MEC) network, a fog network, the Internet, a packet data network (PDN), a service provider network, the World Wide Web (WWW), an IP Multimedia System (IMS) network, a Rich Communication Service (RCS) network, a software defined (SD) network, a virtual network, a packet-switched network, a data center, or other type of network that may provide access to and may host an end device application service or a network application service.

External devices 117 may host one or multiple types of application services. For example, the application services may pertain to broadband services in dense areas (e.g., pervasive video, smart office, operator cloud services, video/photo sharing, etc.), broadband access everywhere (e.g., ultra-low-cost network, etc.), enhanced mobile broadband (eMBB), higher user mobility (e.g., high speed train, remote computing, moving hot spots, etc.), Internet of Things (IoT) services (e.g., smart wearables, sensors, mobile video surveillance, smart cities, connected home, massive IoT (mIoT), critical IoT (cIoT), etc.), extreme real-time communications (e.g., tactile Internet, augmented reality (AR), virtual reality (VR), eXtended reality (XR), mixed reality (MR), etc.), lifeline communications (e.g., natural disaster, emergency response, etc.), ultra-reliable communications (e.g., automated traffic control and driving, collaborative robots, health-related services (e.g., monitoring, remote surgery, etc.), drone delivery, public safety, etc.), broadcast-like services, communication services (e.g., email, text (e.g., Short Messaging Service (SMS), Multimedia Messaging Service (MMS), etc.), massive machine-type communications (mMTC), voice, conferencing, instant messaging), video streaming, gaming (e.g., cloud gaming (CG), etc.), and/or other types of wireless and/or wired application services.

External devices 117 may also include other types of network devices that support the operation of external network 115 and/or the provisioning of application services, such as an orchestrator, an edge manager, an operations support system (OSS), a local domain name system (DNS), registries, a gateway, and/or external devices 117 that may pertain to various network-related functions or services (e.g., security, management, charging, billing, authentication, authorization, policy enforcement, development, communication with other networks, etc.). External devices 117 may include non-virtual, logical, and/or physical network devices.

Core network 120 may include one or multiple networks of one or multiple network types and technologies. Core network 120 may include a complementary network of access network 105. For example, core network 120 may be implemented to include a 5G core network, an evolved packet core (EPC) of an LTE network, a future generation core network (e.g., a 5G Advanced, a 6G, a 7G, or another generation of core network), and/or another type of core network.

Depending on the implementation of core network 120, core network 120 may include diverse types of network devices that are illustrated in FIG. 1 as core devices 122. For example, core devices 122 may include a user plane function (UPF), a Non-3GPP Interworking Function (N3IWF), an access and mobility management function (AMF), a session management function (SMF), a unified data management (UDM) device, a unified data repository (UDR), an authentication server function (AUSF), a network slice selection function (NSSF), a network repository function (NRF), a policy control function (PCF), a network data analytics function (NWDAF), a network exposure function (NEF), a service communication proxy (SCP), a Time Sensitive Communication and Time Sensitive Function (TSCTCF), a future generation core device (e.g., a 5G-Advanced core device, a 6G core device, a 7G core device, etc.), a service capability exposure function (SCEF), a lifecycle management (LCM) device, an application function (AF), a mobility management entity (MME), a packet gateway (PGW), an enhanced packet data gateway (ePDG), a serving gateway (SGW), a home agent (HA), a General Packet Radio Service (GPRS) support node (GGSN), a home subscriber server (HSS), an authentication, authorization, and accounting (AAA) server, a policy and charging rules function (PCRF), a policy and charging enforcement function (PCEF), and a charging system (CS), or a sub-combination thereof. Additionally, core devices 122 may include transport devices (e.g., routers or the like), and a transport control device, such as a path computation engine (PCE).

According to other exemplary implementations, core devices 122 may include additional, different, and/or fewer network devices than those described. For example, core devices 122 may include a non-standard or a proprietary network device, and/or another type of network device that may be well-known but not particularly mentioned herein. Core devices 122 may also include a network device that provides a multi-generation functionality (e.g., 4G and 5G, 5G and 5G Advanced, 5G and 6G, etc.), such as an SMF with PGW control plane functionality (e.g., SMF+PGW-C), a UPF with PGW user plane functionality (e.g., UPF+PGW-U), and/or other types of combined nodes (e.g., an HSS with a UDM and/or UDR, an MME with an AMF, etc.). Also, core devices 122 may include a split core device 122. For example, core devices 122 may include a session management (SM) PCF, an access management (AM) PCF, a user equipment (UE) PCF, and/or another type of split architecture associated with another core device 122, as described herein.

According to an exemplary embodiment, at least some of core devices 122 include logic of an exemplary embodiment of the configuration error management with subscriber privacy service, as described herein. For example, such core devices 122 may include logic that executes a network procedure, a function, an operation, or a communication (e.g., generate and transmit a message) that may contribute to the assignment of a temporary SUCI to end device 130, as described herein. For example, according to an exemplary embodiment, core device 122 may provide the configuration error management with subscriber privacy service based on an error code provided by end device 130, as described herein. According to an exemplary embodiment, core device 122 may provide the configuration error management with subscriber privacy service based on an old or previously used temporary identifier of end device 130, as described herein. According to exemplary embodiment, core device 122 may provide the configuration error management with subscriber privacy service based on a key or a key identifier validated by end device 130, as described herein.

End device 130 includes a device that may have computational and communication capabilities (e.g., wireless, wired, optical, etc.). For example, end device 130 may be implemented as a mobile device, a portable device, a stationary device (e.g., a non-mobile device or a non-portable device), a device operated by a user, or a device not operated by a user. By way of further example, end device 130 may be implemented as a smartphone, a mobile phone, a personal digital assistant, a tablet, a netbook, a wearable device (e.g., a watch, glasses, etc.), a computer (e.g., laptop, palmtop, etc.), a gaming device, a music device, an Internet of Things (IoT) device, a drone, a smart device, a television, a set top box, a media player or streaming device, a telematics device, or another type of wireless device (e.g., another type of UE).

According to an exemplary embodiment, although not illustrated, end device 130 may include one or multiple Universal Integrated Circuit Cards (UICCs), embedded UICCs (eUICCs), Subscriber Identity Module (SIM) cards, chips, secure elements (SEs), integrated trusted execution environments (TEEs), or the like (also referred to generally as a “secure element” or “SE” for description purposes). The secure element may include hardware and may include various types of data, an application, software, an OS, and/or other types of executables that may be stored on and executed by the secure element, for example. The secure element may host a profile, which may include subscription data, security authentication and ciphering information, network configuration information (e.g., roaming files/configuration, etc.), applications, algorithms (e.g., encryption, decryption, etc.), and so forth.

End device 130 may be configured to execute various types of software (e.g., applications, programs, etc.) that enable access and use of various application services, as described herein. The number and the types of software may vary among end devices 130. End devices 130 may include “edge-aware” and/or “edge-unaware” application service clients. For purposes of description, end device 130 is not considered a network device.

According to an exemplary embodiment, the secure element of end device 130 may include logic of the configuration error management with subscriber privacy service. According to an exemplary embodiment, end device 130 may include logic of the configuration error management with subscriber privacy service.

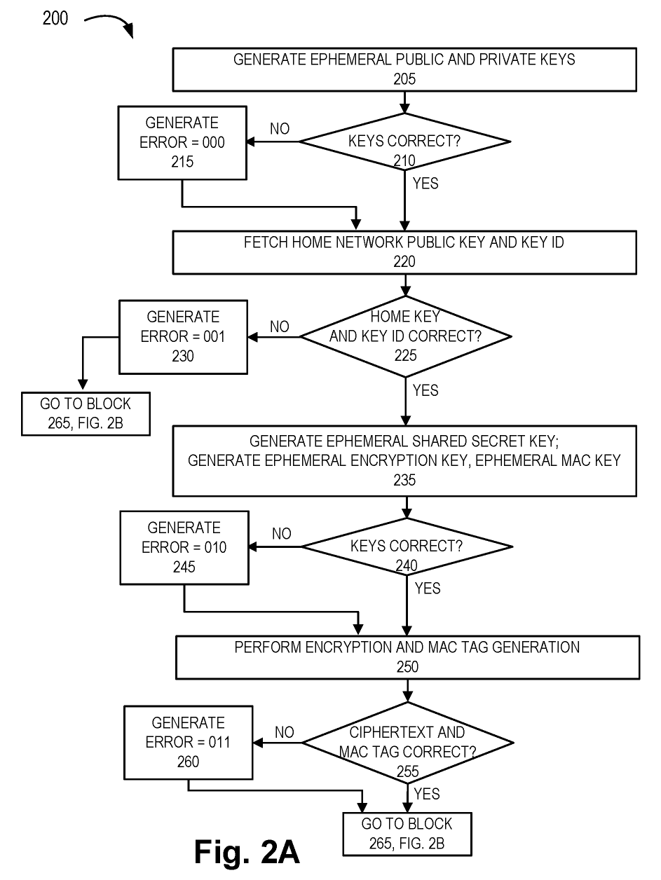

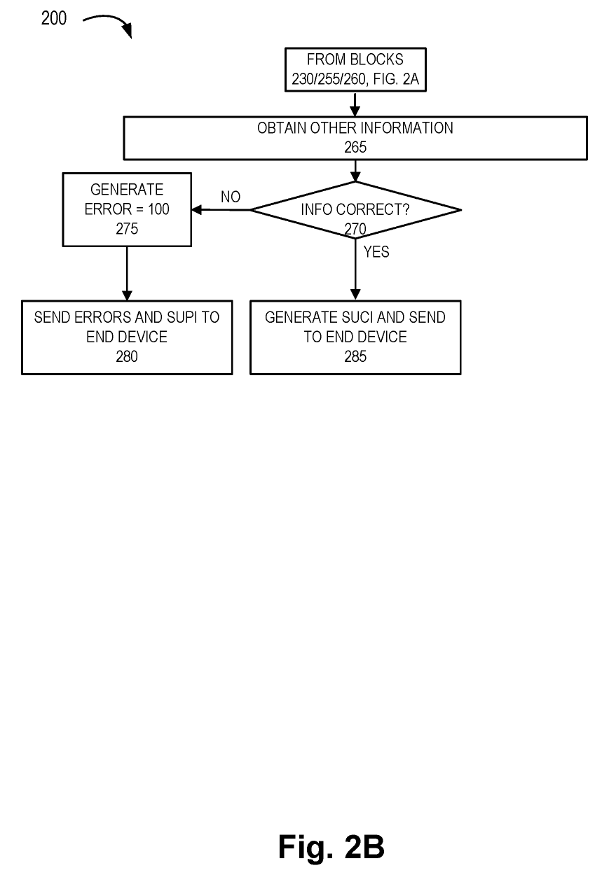

FIGS. 2A and 2B are diagrams illustrating an exemplary process 200 of an exemplary of the configuration error management with subscriber privacy service. According to an exemplary embodiment, process 200 may be performed by the secure element of end device 130. For example, process 200 may be performed a UICC. According to another exemplary embodiment, process 200 may be performed by end device 130. According to yet another exemplary embodiment, one or more steps of process 200 may be collaboratively performed by the secure element of end device 130 and end device 130.

For purposes of description, process 200 is described as performed by the secure element of end device 130. For purposes of description and illustration, the error codes illustrated and described in relation to FIGS. 2A and 2B are exemplary. Accordingly, the error codes may be implemented with different values.

According to various exemplary scenarios and contexts, process 200 may be performed as a part of an initial activation process of end device 130 and/or secure element (e.g., activation of a SIM card or the like) or subsequent to the initial activation during which end device 130 may invoke a procedure to attach to core network 120, register with core network 120, establish a packet data unit (PDU) session, and so forth. According to various exemplary scenarios, secure element and/or end device 130 may be subject to hardware and/or software failure, and/or data corruption, for example, which may otherwise prevent the generation of a SUCI.

Referring to FIG. 2A, in block 205, the secure element may generate ephemeral public and private keys. For example, the secure element may use an Elliptic Curve Integrated Encryption Scheme (ECIES) and an ECIES profile to generate the ephemeral key pair. In response to generating the ephemeral key pair, in block 210, the secure element may check if the ephemeral public key and ephemeral private key are correct. For example, the secure element may analyze one or multiple attributes of the keys, such as length, randomness, constants, patterns, and/or the like.

When the secure element determines that the ephemeral key(s) are not correct (block 210-NO), the secure element may generate an error code (block 215). For example, the error code may be equal to 000 or some other unique value. Process 200 may continue to block 220. When the secure element determines that the ephemeral keys are correct (block 210-YES), the secure element may fetch a home network public key and a home network public key identifier (block 220). For example, the home network public key and the home network public key identifier may be stored by the secure element.

In block 225, the secure element may determine whether the home network public key and the key id are correct. For example, the secure element may analyze one or multiple attributes of the key and key identifier.

When the secure element determines that the home network public key, the key identifier, or both are not correct (block 225-NO), the secure element may generate an error code (block 230). For example, the error code may be equal to 001 or some other unique value. Process 200 may continue to block 265 of FIG. 2B. When the secure element determines that the home network public key and the key identifier are both correct (block 225-YES), the secure element may use an ECIES to generate an ephemeral shared secret key. The secure element may generate an ephemeral encryption key and an ephemeral MAC key based on the ephemeral shared secret key (block 235).

In block 240, the secure element may determine whether the keys are correct. For example, the secure element may analyze one or multiple attributes of the keys.

When the secure element determines that the ephemeral key(s) are not correct (block 240-NO), the secure element may generate an error code (block 245). For example, the error code may be equal to 010 or some other unique value. Process 200 may continue to block 250. When the secure element determines that the ephemeral keys are correct (block 240-YES), the secure element may perform encryption and MAC tag generation (block 250). For example, the secure element may obtain a SUPI and use the ephemeral encryption key to encrypt the SUPI. The secure element may also generate a MAC tag based on the MAC key and the ciphertext of the encrypted SUPI.

In block 255, the secure element may determine whether the ciphertext and the MAC tag are correct. For example, the secure element may analyze one or multiple attributes of the ciphertext and the MAC tag.

When the secure element determines that the ciphertext, the MAC tag, or both are not correct (block 255-NO), the secure element may generate an error code (block 260). For example, the error code may be equal to 011 or some other unique value. Process 200 may continue to block 265 of FIG. 2B. When the secure element determines that the ciphertext and the MAC tag are correct (block 255-YES), the secure element may obtain other information (in block 265 of FIG. 2B). For example, the secure element may obtain an RI, a PLMN identifier, a SUCI type, and/or other information of relevance.

In block 270, the secure element may determine whether the other information is correct. For example, the secure element may analyze one or multiple attributes of the other information.

When the secure element determines that one or multiple instances of the other information are not correct (block 270-NO), the secure element may generate an error code (block 275). For example, the error code may be equal to 100 or some other unique value. In block 280, the secure element may concatenate the error codes and send the error codes and the SUPI to end device 130.

According to some exemplary embodiments, the secure element may invoke an alert to a user of end device 130. For example, the secure element and/or end device 130 may generate or display a screen, a graphic, or another form of a graphic user interface, which notifies the user that there is an issue regarding the generation of the SUCI. The alert may also provide information regarding remedial measures, such as options for the user, such as calling customer care, going to a store, etc. Additionally, or alternatively, the alert may indicate, when available, that end device 130 may attempt to register with the network (e.g., core network 120). For example, as described herein, when a temporary identifier, an HNPK, or a Master Shared Secret (MSS) key is available, one of processes 300, 400, or 500 may be executed.

When secure element determines that the other information is correct (block 270-YES), the secure element may generate a SUCI and send the SUCI to end device 130 (block 285). End device 130 may send the SUCI as a part of a 5G network registration procedure to access device 107.

FIGS. 2A and 2B illustrate exemplary process 200 of the configuration error management with subscriber privacy service. However, according to other exemplary embodiments, the configuration error management with subscriber privacy service may perform additional operations, fewer operations, and/or different operations than those illustrated and described. For example, process 200 may omit the generation of one or multiple types of keys, as described herein. According to another example, process 200 may generate a different type of key than that described. According to yet another example, process 200 may perform only a portion of process 200, such as determining whether the HNPK and HNPK identifier are correct, or another portion of process 200.

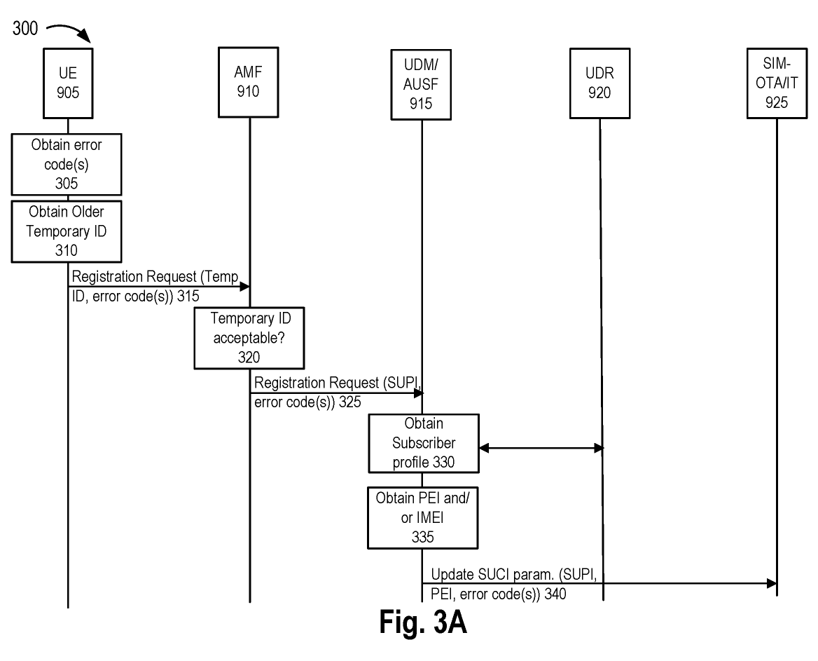

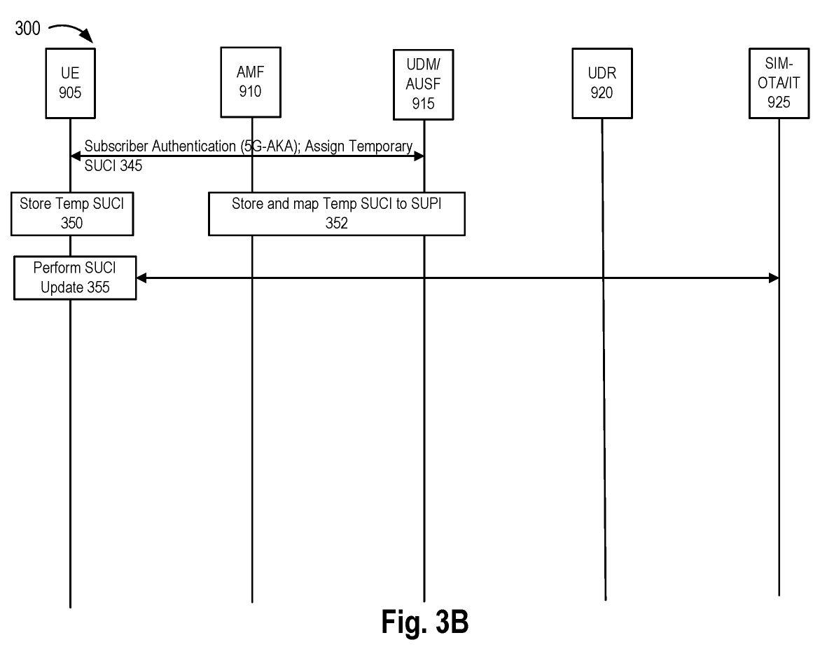

FIGS. 3A and 3B are diagrams illustrating exemplary steps and exemplary messaging of an exemplary process 300 of the configuration error management with subscriber privacy service. As illustrated, an exemplary environment may involve exemplary network devices, such as an AMF 910, a UDM/AUSF 915, a UDR 920, and a Subscriber Identity Module Over-the-Air device (SIM-OTA)/Information Technology (IT) device 925. The environment also involves a UE 905.

AMF 910, UDM/AUSF 915, and UDR 920 are each an exemplary implementation of core device 122 that provides or supports the configuration error management with subscriber privacy service. According to other exemplary environments, different, additional, or fewer core devices 122 may be implemented with the configuration error management with subscriber privacy service. SIM-OTA/IT device 925 is an exemplary implementation of external device 117 or core device 122, for example. SIM-OTA/IT device 925 may include a SIM-OTA server, a device management (DM) server, or similar provisioning network device for secure elements and/or end devices 130, for example. SIM-OTA/IT device 925 may also manage secure element replacements, upgrades, and the like, as described herein. UE 905 is an exemplary implementation of end device 130.

According to an exemplary embodiment, UE 905, AMF 910, UDM/AUSF 915, and UDR 920 may each include logic that performs an operation or provides a function that is in accordance with a technical specification associated with a network standardizing body, such as 3GPP, 3GPP2, ITU, ETSI, GSMA, or the like. According to an exemplary embodiment, UE 905, AMF 910, UDM/AUSF 915, UDR 920, and SIM OTA/IT device 925 may each include logic of the configuration error management with subscriber privacy service, as described herein.

According to an exemplary embodiment of process 300, UE 905 may store a previously used or older temporary identifier of UE 905. For example, the temporary identifier may be implemented as a 5G-Globally Unique Temporary Identifier (5G-GUTI), a 5G Temporary Mobile Subscriber Identity (5G-TMSI), or a previously generated 5G-SUCI..

Referring to FIG. 3A, UE 905 may obtain one or multiple error codes 305 from the secure element of UE 905. For example, the secure element may provide the error code(s) to UE 905 as a part of step 280 of process 200. UE 905 may obtain the older temporary identifier 310 of UE 905, such as a 5G-GUTI, a 5G-TMSI, or previously generated 5G-SUCI, which may have been obtained and stored from a previous registration procedure between core network 120 and UE 905. According to some exemplary embodiments, UE 905 may select the use of the temporary identifier versus the use of a HNPK, as described herein, based on the presence of the error code(s) indicating that the HNPK is not valid or incorrect.

In response, UE 905 may generate and transmit a registration request 315 to AMF 910 via access network 105 (not illustrated). Registration request 315 may include the temporary identifier and the error code(s). In response to receiving and interpreting request 315, AMF 910 may determine whether the temporary identifier is acceptable 320. For example, AMF 910 may use the temporary identifier as a key to search context information and recover the SUPI of UE 905.

In response, AMF 910 may generate and transmit a registration request 325 to UDM/AUSF 915. Registration request 325 may include the SUPI of UE 905 and the error code(s). In response to receiving and interpreting request 325, UDM/AUSF 915 may obtain the subscriber profile 330 of UE 905 from UDR 920. For example, UDM/AUSF 915 may obtain the subscriber profile based on the SUPI of UE 905. UDM/AUSF 915 may obtain an equipment identifier 335 of UE 905. For example, the equipment identifier of UE 905 may be implemented as a Physical Equipment Identifier (PEI) or an International Mobile Equipment Identifier (IMEI). UDM/AUSF 915 may obtain the equipment identifier based on the SUPI of UE 905. UDM/AUSF 915 may generate and transmit an update 335 to SIM-OTA/IT device 925. For example, update 335 may include the SUPI, the equipment identifier, and the error code(s)). Update 335 may include data indicating a request to update SUCI parameters associated with UE 905.

Referring to FIG. 3B, UDM/AUSF 915 and UE 905 may perform a subscriber authentication procedure and based on a successful authentication procedure a temporary SUCI may be assigned 345. UE 905 may store the temporary SUCI 350. AMF 910 and UDM/AUSF 915 may store and map 352 the temporary SUCI to the SUPI of UE 905. UDM/AUSF 915 may also store the temporary SUCI assigned to UE 905 within UDR 920. UE 905 may perform a SUCI update procedure 355 with SIM-OTA/IT device 925. For example, the SUCI update procedure may include updating one or multiple SUCI parameters, such as SUPI type, home network identifier, RI, protection scheme, and/or the like. According to some exemplary scenarios, the SUCI update procedure may include SIM-OTA/IT device 925 determining that the secure element (e.g., SIM card, etc.) of UE 905 may need to be replaced.

FIGS. 3A and 3B illustrate and describe an exemplary process 300 of the configuration error management with subscriber privacy service. However, according to other exemplary embodiments, process 300 may include additional, fewer, and/or different operations relative to those illustrated and described according to other potential scenarios and/or context. The messages illustrated and described are exemplary.

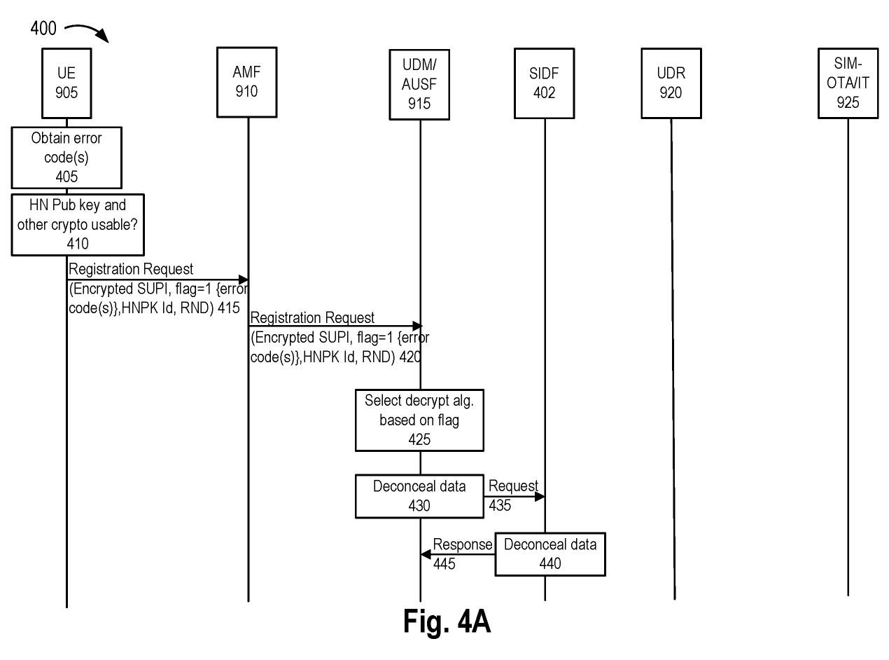

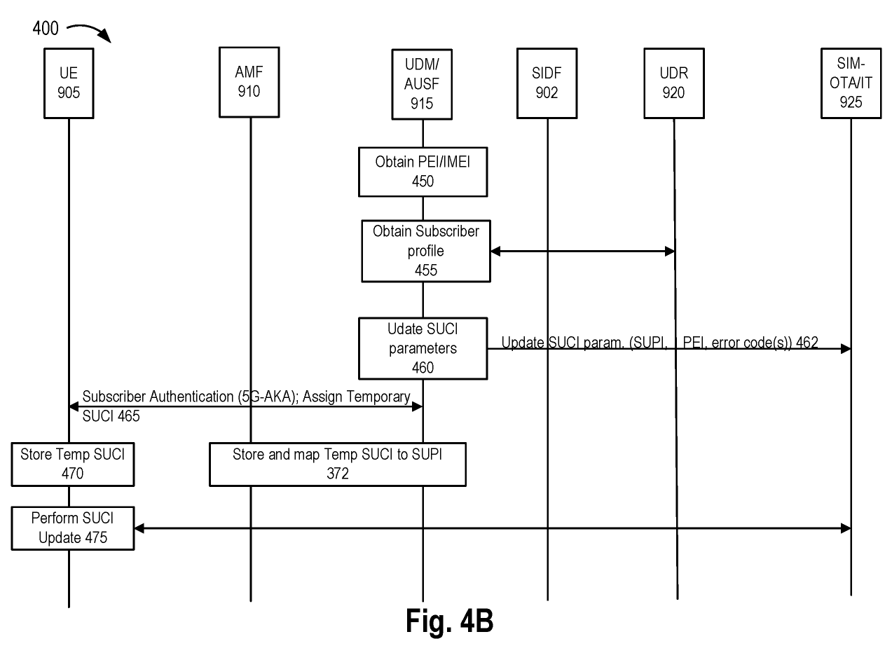

FIGS. 4A and 4B are diagrams illustrating exemplary steps and exemplary messaging of an exemplary process 400 of the configuration error management with subscriber privacy service. As illustrated, an exemplary environment may involve exemplary network devices, such as those previously described in relation to process 300. Additionally, the exemplary environment may include a Subscriber Identity De-Concealing Function (SIDF) 402. It is noted that an SIDF is a functional element of a UDM, such as UDM/AUSF 915. However, for purposes of clarity of description of process 400, SIDF 402 is separately illustrated and described.

According to an exemplary embodiment, SIDF 402 may include logic that performs an operation or provides a function that is in accordance with a technical specification associated with a network standardizing body, such as 3GPP, 3GPP2, ITU, ETSI, GSMA, or the like. According to an exemplary embodiment, SIDF 402 may include logic of the configuration error management with subscriber privacy service, as described herein. SIDF 402 is an exemplary implementation of core device 122.

Referring to FIG. 4A, UE 905 may obtain one or multiple error codes 405 from the secure element of UE 905. For example, the secure element may provide the error code(s) to UE 905 as a part of step 280 of process 200. UE 905 may determine, based on the error code(s) that the HNPK and the encrypted SUPI are valid 410. For example, UE 905 may identify the absence of error code= 001, whereby the presence of error code=001 may be used to indicate that the HNPK and HNPK identifier are not correct, as previously described in relation to process 200.

In response, UE 905 may generate and transmit a registration request 415 to AMF 910 via access network 105 (not illustrated). Registration request 415 may include an encrypted SUPI, the HNPK identifier, a flag (e.g., illustrated as flag=1), the error code(s), and a random number (RND). According to some exemplary embodiments, the HNPK identifier, the error code(s), and the flag or a subset thereof may be encrypted. The RND may be used as a part of the encryption process to ensure the encrypted result does not appear deterministic. In response to receiving and interpreting request 415, AMF 910 may generate and transmit a registration request 420 to UDM/AUSF 915, or alternatively forward request 415 to UDM/AUSF 915. Registration request 420 may include the encrypted SUPI, the HNPK identifier, the flag, the error code(s), and the RND.

In response to receiving and interpreting request 415 or request 420, UDM/AUSF 915 may select an appropriate decryption algorithm based on the flag 425, and determine to decrypt or de-conceal data 430. For example, UDM/AUSF 915 may generate and transmit a request 435 to SIDF 402. Request 435 may include the encrypted SUPI, the HNPK identifier, the RND, and the error code(s)). According to this example, the decryption algorithm type may correspond to an HNPK type. In response to request 435, SIDF 402 may de-conceal the data 440. For example, SIDF 402 may select the decryption algorithm type based on the HNPK identifier and decrypt the encrypted SUPI and the error code(s) using the RND. Upon completion, SIDF 402 may generate and transmit a response 445, which may include the SUPI and the error code(s).

Referring to FIG. 4B, in response to receiving the SUPI and the error code(s), UDM/AUSF 915 may obtain an equipment identifier 450 of UE 905, such as a PEI and/or an IMEI. UDM/AUSF 915 may determine to re-provision the SUCI parameter of UE 905 based on the error code(s). As illustrated, UDM/AUSF 915 may obtain the subscriber profile 455 from UDR. Additionally, UDM/AUSF 915 may update the SUCI parameters 460 with SIM-OTA/IT device 925. For example, an update 462 may include the SUPI and the equipment identifier of UE 905, and the error code(s)).

Similar to process 300, UDM/AUSF 915 and UE 905 may perform a subscriber authentication procedure and a temporary SUCI may be assigned 465. UE 905 may store the temporary SUCI 470. AMF 910 and UDM/AUSF 915 may store and map 372 the temporary SUCI to the SUPI of UE 905. UDM/AUSF 915 may also request that UDR 920 store the temporary SUCI assigned to UE 905 within UDR 920. UE 905 may perform a SUCI update procedure 475 with SIM-OTA/IT device 925 in a manner similar to that previously described.

FIGS. 4A and 4B illustrate and describe an exemplary process 400 of the configuration error management with subscriber privacy service. However, according to other exemplary embodiments, process 400 may include additional, fewer, and/or different operations relative to those illustrated and described according to other potential scenarios and/or context. The messages illustrated and described are exemplary.

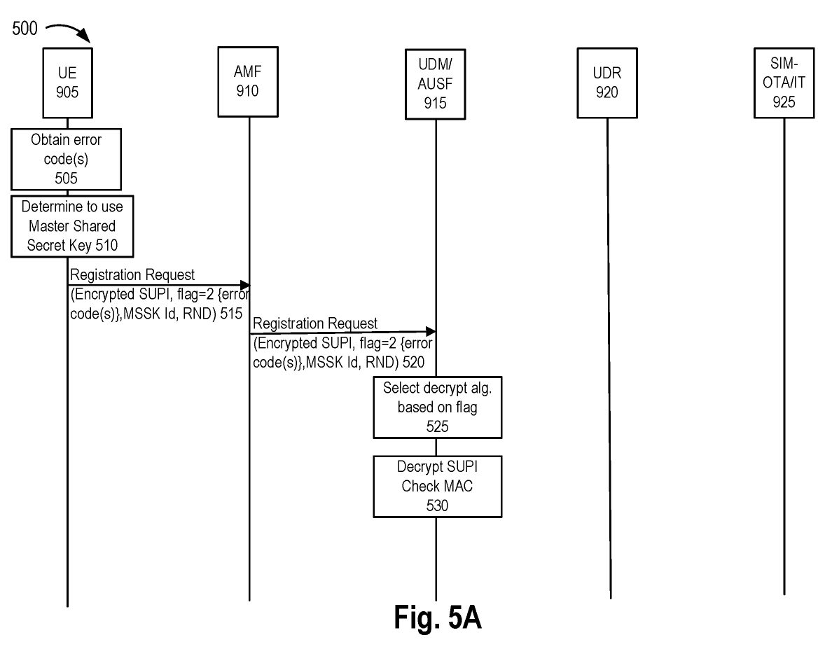

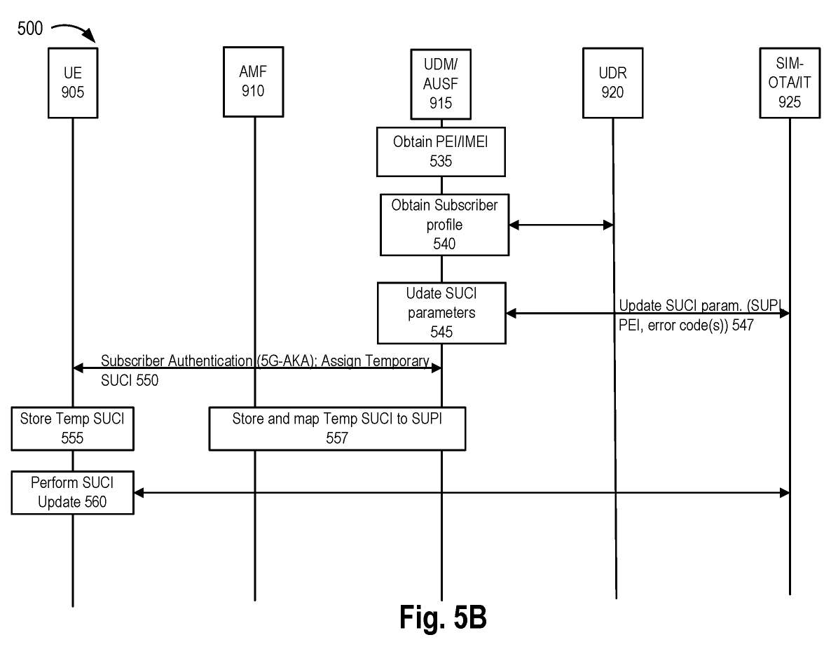

FIGS. 5A and 5B are diagrams illustrating exemplary steps and exemplary messaging of an exemplary process 400 of the configuration error management with subscriber privacy service. As illustrated, an exemplary environment may involve exemplary network devices, such as those previously described in relation to process 300 and process 400.

Referring to FIG. 5A, UE 905 may obtain one or multiple error codes 505 from the secure element of UE 905. For example, the secure element may provide the error code(s) to UE 905 as a part of step 280 of process 200. UE 905 may determine, based on the error code(s) that the HNPK is not valid, but the MSS key is valid 510. For example, the MSS key may be provisioned in the secure element and/or end device 130. According to some exemplary implementations, the MSS key may be provisioned by the network operator, wireless service provider or similar entity pertaining to a user of end device 130 or end device 130.

In response, UE 905 may generate and transmit a registration request 515 to AMF 910 via access network 105 (not illustrated). Registration request 515 may include the encrypted SUPI, a flag (e.g., illustrated as flag=2), the error code(s), a Master Shared Secret Key (MSSK) identifier, a MAC tag, encryption algorithm identifier, and a random number (RND). According to some exemplary embodiments, the flag, the error code(s), and the MSSK identifier, or a subset thereof may also be encrypted. The RND may be used as a part of an encryption process to ensure the encrypted result does not appear deterministic. The MAC tag is generated in order to ensure the integrity and authenticity of the data that is transmitted in registration request 515. In response to receiving and interpreting request 515, AMF 910 may generate and transmit a registration request 520 to UDM/AUSF 915, or alternatively forward request 515 to UDM/AUSF 915. Registration request 520 may include the encrypted SUPI, the MSSK identifier, the flag, the error code(s), a MAC tag, and the RND.

In response to receiving and interpreting request 515 or request 520, UDM/AUSF 915 may select an appropriate decryption algorithm based on the flag 525, and determine to decrypt the SUPI and the error code(s) and check the authenticity and integrity of MAC tag 530. For example, UDM/AUSF 915 may select the decryption algorithm type based on the MSSK identifier and decrypt the encrypted SUPI and the error code(s) using the RND. Additionally, UDM/AUSF 915 may check the authenticity and integrity of the MAC tag based on attributes associated with the MAC tag. The encryption/decryption algorithms may be based on Authenticated Encryption using Associated Data (AEAD) type of encryption scheme (e.g., AES-GCM mode), wherein the encryption/decryption as well as the integrity/authenticity algorithm is the same and identifiable using the same.

Referring to FIG. 5B, in response to obtaining the SUPI and the error code(s) (i.e., decrypted), UDM/AUSF 915 may obtain an equipment identifier 535 of UE 905, such as a PEI and/or an IMEI. UDM/AUSF 915 may determine to re-provision the SUCI parameter of UE 905 based on the error code(s). As illustrated, UDM/AUSF 915 may obtain the subscriber profile 540 from UDR. Additionally, UDM/AUSF 915 may update the SUCI parameters 545 with SIM-OTA/IT device 925. For example, an update 547 may include the SUPI and the equipment identifier of UE 905, and the error code(s)).

Similar to process 300, UDM/AUSF 915 and UE 905 may perform a subscriber authentication procedure and a temporary SUCI may be assigned 550. UE 905 may store the temporary SUCI 555. UDM/AUSF 915 may also request UDR 920 to store the temporary SUCI assigned to UE 905 within UDR 920. AMF 910 and UDM/AUSF 915 may store and map 557 the temporary SUCI to the SUPI of UE 905. UE 905 may perform a SUCI update procedure 560 with SIM-OTA/IT device 925 in a manner similar to that previously described.

FIGS. 5A and 5B illustrate and describe an exemplary process 500 of the configuration error management with subscriber privacy service. However, according to other exemplary embodiments, process 500 may include additional, fewer, and/or different operations relative to those illustrated and described according to other potential scenarios and/or context. The messages illustrated and described are exemplary.

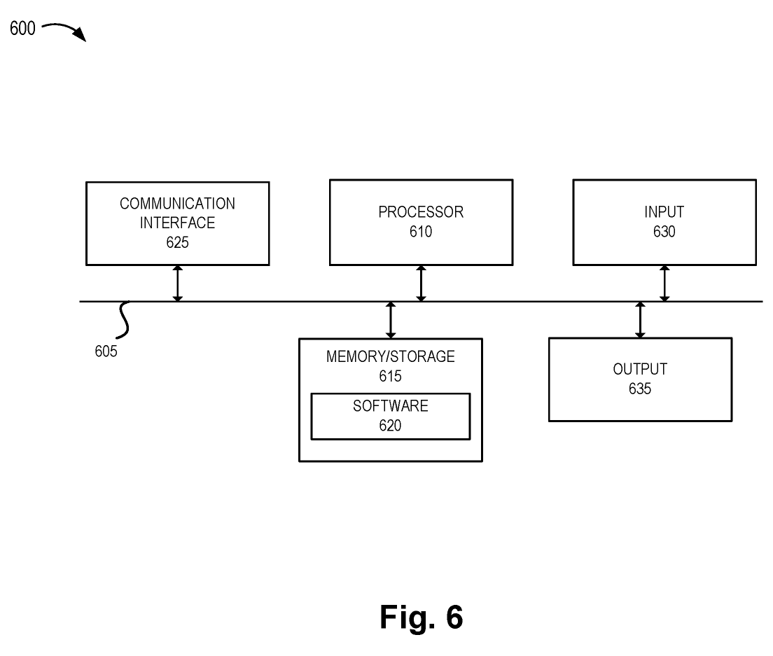

FIG. 6 is a diagram illustrating exemplary components of a device that may correspond to one or more of the devices illustrated and described herein. For example, device 600 may correspond to access device 107, external device 117, core device 122, end device 130, and/or other types of devices, as described herein. As illustrated in FIG. 6, device 600 includes a bus 605, a processor 610, a memory/storage 615 that stores software 620, a communication interface 625, an input 630, and an output 635. According to other embodiments, device 600 may include fewer components, additional components, different components, and/or a different arrangement of components than those illustrated in FIG. 6 and described herein.

Bus 605 includes a path that permits communication among the components of device 600. For example, bus 605 may include a system bus, an address bus, a data bus, and/or a control bus. Bus 605 may also include bus drivers, bus arbiters, bus interfaces, clocks, and so forth.

Processor 610 includes one or multiple processors, microprocessors, data processors, co-processors, graphics processing units (GPUs), application specific integrated circuits (ASICs), controllers, programmable logic devices, chipsets, field-programmable gate arrays (FPGAs), application specific instruction-set processors (ASIPs), system-on-chips (SoCs), central processing units (CPUs) (e.g., one or multiple cores), microcontrollers, neural processing unit (NPUs), quantum processors, future generation processors or execution environments, and/or some other type of component that interprets and/or executes instructions and/or data. Processor 610 may be implemented as hardware (e.g., a microprocessor, etc.), a combination of hardware and software (e.g., a SoC, an ASIC, etc.), may include one or multiple memories (e.g., cache, etc.), etc.

Processor 610 may control the overall operation, or a portion of operation(s) performed by device 600. Processor 610 may perform one or multiple operations based on an operating system and/or various applications or computer programs (e.g., software 620). Processor 610 may access instructions from memory/storage 615, from other components of device 600, and/or from a source external to device 600 (e.g., a network, another device, etc.). Processor 610 may perform an operation and/or a process based on various techniques and/or technologies including, for example, multithreading, parallel processing, pipelining, interleaving, machine learning, artificial intelligence, etc.

Memory/storage 615 includes one or multiple memories and/or one or multiple other types of storage mediums. For example, memory/storage 615 may include one or multiple types of memories, such as, a random access memory (RAM), a dynamic RAM (DRAM), a static RAM (SRAM), a cache, a read only memory (ROM), a programmable ROM (PROM), an erasable PROM (EPROM), an electrically EPROM (EEPROM), a single in-line memory module (SIMM), a dual in-line memory module (DIMM), a flash memory (e.g., 2D, 3D, NOR, NAND, etc.), a solid state memory, and/or some other type of memory. Memory/storage 615 may include a hard disk (e.g., a magnetic disk, an optical disk, a magneto-optic disk, a solid-state component, etc.), a Micro-Electromechanical System (MEMS)-based storage medium, and/or a nanotechnology-based storage medium.

Memory/storage 615 may be external to and/or removable from device 600, such as, for example, a Universal Serial Bus (USB) memory stick, a dongle, a hard disk, a solid state drive, mass storage, off-line storage, cloud storage, or some other type of storing medium. Memory/storage 615 may store data, software, and/or instructions related to the operation of device 600.

Software 620 includes an application or a program that provides a function and/or a process. As an example, with reference to core device 122, software 620 may include an application that, when executed by processor 610, provides a function and/or a process of the configuration error management with subscriber privacy service, as described herein. According to another example, with reference to end device 130, software 620 may include an application that, when executed by processor 610, provides a function and/or a process of the configuration error management with subscriber privacy service, as described herein. Software 620 may also include firmware, middleware, microcode, hardware description language (HDL), and/or other form of instruction. Software 620 may also be virtualized. Software 620 may further include an operating system.

Communication interface 625 permits device 600 to communicate with other devices, networks, systems, and/or the like. Communication interface 625 includes one or multiple wireless interfaces, optical interfaces, and/or wired interfaces. For example, communication interface 625 may include one or multiple transmitters and receivers, or transceivers. Communication interface 625 may operate according to a protocol stack and a communication standard.

Input 630 permits an input into device 600. For example, input 630 may include a keyboard, a mouse, a display, a touchscreen, a touchless screen, a button, a switch, an input port, a joystick, speech recognition logic, and/or some other type of visual, auditory, tactile, affective, olfactory, etc., input component. Output 635 permits an output from device 600. For example, output 635 may include a speaker, a display, a touchscreen, a touchless screen, a light, an output port, and/or some other type of visual, auditory, tactile, etc., output component.

As previously described, a network device may be implemented according to various computing architectures (e.g., in a cloud, etc.) and according to various network architectures (e.g., a virtualized function, PaaS, etc.). Device 600 may be implemented in the same manner. For example, device 600 may be instantiated, created, spun-up, uninstantiated, deleted, spun-down, or some other operational state during its life cycle (e.g., refreshed, paused, suspended, rebooting, or another type of state or status), using well-known virtualization technologies. For example, access device 107, core device 122, external device 117, and/or another type of network device or end device 130, as described herein, may be a virtualized device.

Device 600 may perform a process and/or a function, as described herein, in response to processor 610 executing software 620 stored by memory/storage 615. By way of example, instructions may be read into memory/storage 615 from another memory/storage 615 (not shown) or read from another device (not shown) via communication interface 625. The instructions that are stored by memory/storage 615 may configure and cause processor 610 to perform a function or a process described herein. Alternatively, for example, according to other implementations, device 600 performs a function or a process described herein based on the execution of hardware (processor 610, etc.).

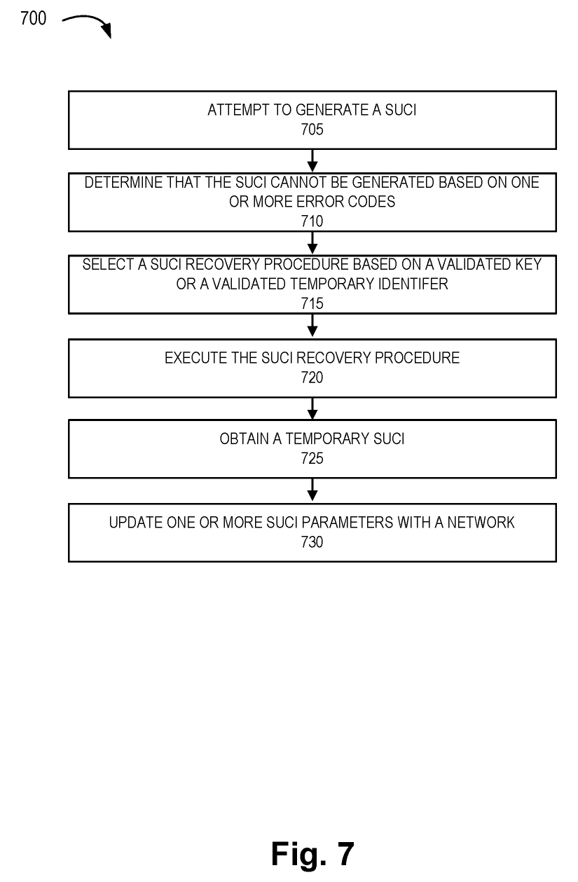

FIG. 7 is a flow diagram illustrating an exemplary process 700 of an exemplary embodiment of the configuration error management with subscriber privacy service. According to an exemplary embodiment, end device 130 or a secure element of end device 130, as described herein, may perform a step of process 700. According to other exemplary embodiments, one or more steps of process 700 may be performed by end device 130 and secure element. According to an exemplary implementation, processor 610 executes software 620 to perform a step of process 700, as described herein. Alternatively, a step may be performed by execution of only hardware. For purposes of description, process 700 is described as performed by end device 130.

Referring to FIG. 7, in block 705, end device 130 may attempt to generate a SUCI. For example, end device 130 may perform process 200, as described herein.

In block 710, end device 130 may determine that the SUCI cannot be generated based on one or multiple error codes. For example, during the attempted generation of the SUCI, one or more error codes may be generated, as described herein.

In block 715, end device 130 may select a SUCI recovery procedure based on a validated key or a previously used temporary identifier. For example, end device 130 may be configured to perform multiple SUCI recovery procedures, as described in relation to processes 300, 400 and 500. However, depending on the available information (e.g., older temporary ID, a valid HNPK, master shared secret key), end device 130 may select from these multiple candidate SUCI recovery procedures. For example, end device 130 may determine based on the presence or the absence of the one or more error codes an available SUCI recovery procedure. For example, end device 130 may select the SUCI recovery procedure that may use a public key, such as the HNPK, as described herein. According to another example, regardless of the presence or the absence of the one or more error codes, end device 130 may select the SUCI recovery procedure that may use a previously stored temporary identifier (e.g., a 5G-GUTI or a 5G TMSI). According to yet another example, may select the SUCI recovery procedure that may use a shared key, such as the MSS key, as described herein, when a SUPI of end device 130 is correct, which may be indicated based on the absence of the one or more error codes, as described herein. According to an exemplary embodiment, when multiple SUCI recovery procedures are available, end device 130 may select one procedure over another procedure based on a priority value associated with the procedure. For example, one procedure may be afforded a priority or a preference over another procedure. The priority or preference value may be based on a configurable metric (e.g., success rate, etc.).

In block 720, end device 130 may execute the selected SUCI recovery procedure. For example, end device 130 may execute the SUCI recovery procedure with core network 120. End device 130 may generate and transmit a registration request, which may include the one or more error codes, and the validated key (e.g., HNPK, MSS key) or the temporary identifier, as described herein.

In block 725, end device 130 may obtain a temporary SUCI. For example, based on the execution of the SUCI recovery procedure, core network 120 may provide the temporary SUCI to end device 130, as described herein.

In block 730, end device 130 may update one or more SUCI parameters with a network. For example, end device 130 may communicate with SIM-OTA/IT device 925 to update the SUCI parameters associated with the temporary SUCI, as described herein.

FIG. 7 illustrates an exemplary process 700 of the configuration error management with subscriber privacy service, according to other exemplary embodiments, the configuration error management with subscriber privacy service may perform additional operations, fewer operations, and/or different operations than those illustrated and described.

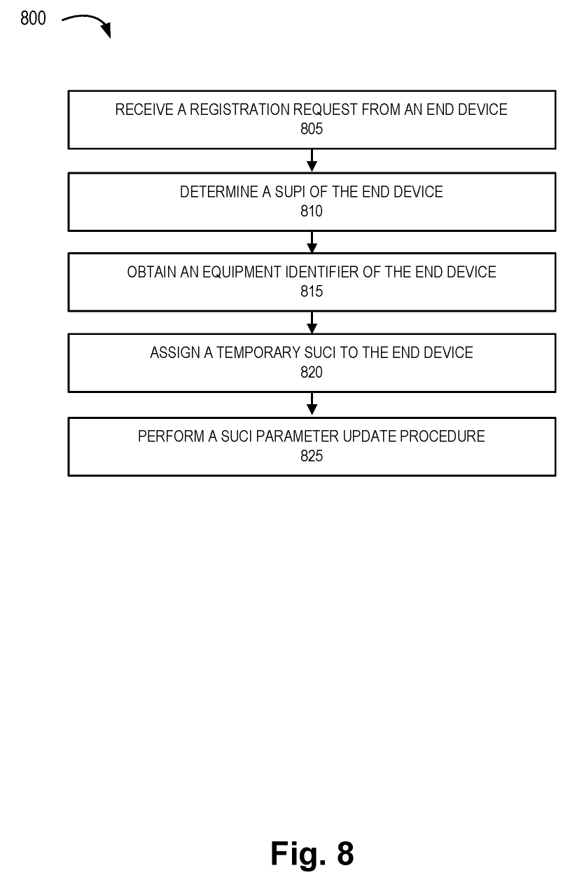

FIG. 8 is a flow diagram illustrating an exemplary process 800 of an exemplary embodiment of the configuration error management with subscriber privacy service. According to an exemplary embodiment, core devices 122 of core network 120, as described herein, may perform process 800. According to an exemplary implementation, processor 610 executes software 620 to perform a step of process 800, as described herein. Alternatively, a step may be performed by execution of only hardware. For purposes of description, process 800 is described as performed by core network 120. One or more steps of process 800 may relate to one or more steps of process 300, 400, and 500, or a subset thereof.

Referring to FIG. 8, in block 805, core network 120 may receive a registration request from end device 130. For example, the registration request may include an error code pertaining to a failed attempt to generate a SUCI, as described herein. The registration request may include a HNPK identifier, a temporary identifier, or an MMS key, as described herein.

In block 810, core network 120 may determine a SUPI of end device 130. For example, the registration request may include an encrypted SUPI, which is decrypted by core network 120, or the SUPI is obtained based on the temporary identifier.

In block 815, core network 120 may obtain an equipment identifier of end device 130. For example, based on the subscription profile of end device 130, core network 120 may determine the equipment identifier.

In block 820, core network 120 may assign a temporary SUCI to end device 130. For example, based on the SUPI and the subscription profile, core network 120 may generate and provide the temporary SUCI to end device 130.

In block 825, core network 120 may update the temporary SUCI parameters with end device 130, as described herein.

FIG. 8 illustrates an exemplary process 800 of the configuration error management with subscriber privacy service, according to other exemplary embodiments, the configuration error management with subscriber privacy service may perform additional operations, fewer operations, and/or different operations than those illustrated and described. For example, block 825 may be performed by external device 117, as described herein.

As set forth in this description and illustrated by the drawings, reference is made to “an exemplary embodiment,” “exemplary embodiments,” “an embodiment,” “embodiments,” etc., which may include a particular feature, structure, or characteristic in connection with an embodiment(s). However, the use of the phrase or term “an embodiment,” “embodiments,” etc., in various places in the description does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

The foregoing description of embodiments provides illustration but is not intended to be exhaustive or to limit the embodiments to the precise form disclosed. Accordingly, modifications to the embodiments described herein may be possible. For example, various modifications and changes may be made thereto, and additional embodiments may be implemented, without departing from the broader scope of the invention as set forth in the claims that follow. For example, although examples of the configuration error management with subscriber privacy service have been provided regarding core devices 122, the service may be implemented for access devices 107 of a RAN, for example. The description and drawings are accordingly to be regarded as illustrative rather than restrictive.

The terms “a,” “an,” and “the” are intended to be interpreted to include one or more items. Further, the phrase “based on” is intended to be interpreted as “based, at least in part, on,” unless explicitly stated otherwise. The term “and/or” is intended to be interpreted to include any and all combinations of one or more of the associated items. The word “exemplary” is used herein to mean “serving as an example.” The term “substantially” is used herein to represent a degree by which a quantitative representation may vary from a stated reference without resulting in a change in the basic function of the subject matter at issue.

Any embodiment or implementation described as “exemplary” is not necessarily to be construed as preferred or advantageous over other embodiments or implementations.

In addition, while series of blocks have been described regarding the processes illustrated in FIGS. 2A, 2B, 7, and 8, the order of the blocks may be modified according to other embodiments. Further, non-dependent blocks may be performed in parallel. Additionally, other processes described in this description and illustrated in the drawings may be modified and/or non-dependent operations may be performed in parallel.

Embodiments described herein may be implemented in many different forms of software executed by hardware. For example, a process or a function may be implemented as “logic” or a “component.” The logic or the component may include, for example, hardware (e.g., processor 610, etc.), or a combination of hardware and software (e.g., software 620).

Embodiments have been described without reference to the specific software code because the software code can be designed to implement the embodiments based on the description herein and commercially available software design environments and/or languages. For example, diverse types of programming languages including, for example, a compiled language, an interpreted language, a declarative language, or a procedural language may be implemented.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

Additionally, embodiments described herein may be implemented as a non-transitory computer-readable storage medium that stores data and/or information, such as instructions, program code, a data structure, a program module, an application, a script, or other known or conventional form suitable for use in a computing environment. The program code, instructions, application, etc., is readable and executable by a processor (e.g., processor 610) of a device. A non-transitory storage medium includes one or more of the storage mediums described in relation to memory/storage 615. The non-transitory computer-readable storage medium may be implemented in a centralized, distributed, or logical division that may include a single physical memory device or multiple physical memory devices spread across one or multiple network devices.

To the extent the aforementioned embodiments collect, store, or employ personal information of individuals, it should be understood that such information shall be collected, stored, and used in accordance with all applicable laws concerning protection of personal information. Additionally, the collection, storage and use of such information can be subject to the consent of the individual to such activity, for example, through well known “opt-in” or “opt-out” processes as can be appropriate for the situation and type of information. Collection, storage, and use of personal information can be in an appropriately secure manner reflective of the type of information, for example, through various encryption and anonymization techniques for particularly sensitive information.

No element, act, or instruction set forth in this description should be construed as critical or essential to the embodiments described herein unless explicitly indicated as such.

All structural and functional equivalents to the elements of the various aspects set forth in this disclosure that are known or later become known are expressly incorporated herein by reference and are intended to be encompassed by the claims.

What is claimed is:

1. A method comprising:
determining, by a device, that a Subscriber Concealed Identifier (SUCI) cannot be generated;
selecting, by the device, from multiple candidate SUCI recovery procedures, a SUCI recovery procedure;
executing, by the device, the SUCI recovery procedure with a core network;
obtaining, by the device from the core network, a temporary SUCI; and
updating, by the device, one or more parameters associated with the temporary SUCI.

2. The method of claim 1, wherein the selecting comprises:
selecting, by the device, the SUCI recovery procedure based on a stored temporary identifier.

3. The method of claim 1, wherein the selecting comprises:
selecting, by the device, the SUCI recovery procedure based on a stored master shared key.

4. The method of claim 1, wherein the selecting comprises:
selecting, by the device, the SUCI recovery procedure based on an absence of an error code resulting from a previous failed attempt to generate the SUCI or a presence of a home network key.

5. The method of claim 1, wherein the executing comprises:
transmitting, by the device to the core network, a registration request that includes an error code associated with a failed attempt to generate the SUCI and a temporary identifier of a user of the device.

6. The method of claim 1, wherein the executing comprises:
transmitting, by the device to the core network, a registration request that includes an error code associated with a failed attempt to generate the SUCI and a master shared secret key.

7. The method of claim 1, further comprising:
attempting, by the device prior to the determining, to generate the SUCI; and
failing, by the device during the attempting, to generate the SUCI.

8. The method of claim 1, wherein the executing comprises:
transmitting, by the device to the core network, a registration request that includes an error code associated with a failed attempt to generate the SUCI.

9. A device comprising:
a processor that is configured to:
determine that a Subscriber Concealed Identifier (SUCI) cannot be generated;
select from multiple candidate SUCI recovery procedures, a SUCI recovery procedure;
execute the SUCI recovery procedure with a core network;
obtain, from the core network, a temporary SUCI; and
update one or more parameters associated with the temporary SUCI.

10. The device of claim 9, wherein when selecting, the processor is further configured to:
select the SUCI recovery procedure based on a stored temporary identifier.

11. The device of claim 9, wherein when selecting, the processor is further configured to:
select the SUCI recovery procedure based on an absence of an error code resulting from a previous failed attempt to generate the SUCI or a presence of a home network key.

12. The device of claim 9, wherein when selecting, the processor is further configured to:
select the SUCI recovery procedure based on a stored master shared key.

13. The device of claim 9, wherein when executing, the processor is further configured to:
transmit to the core network, a registration request that includes an error code associated with a failed attempt to generate the SUCI and a temporary identifier of a user of the device.

14. The device of claim 9, wherein when executing, the processor is further configured to:
transmit to the core network, a registration request that includes an error code associated with a failed attempt to generate the SUCI and a master shared secret key.

15. The device of claim 9, wherein when executing, the processor is further configured to:
transmit to the core network, a registration request that includes an error code associated with a failed attempt to generate the SUCI.

16. The device of claim 9, wherein the processor is further configured to:
attempt, prior to a determination that the SUCI cannot be generated, to generate the SUCI; and
fail to generate the SUCI.

17. A non-transitory computer-readable storage medium storing instructions executable by a processor of a device, wherein the instructions are configured to:
determine that a Subscriber Concealed Identifier (SUCI) cannot be generated;
select from multiple candidate SUCI recovery procedures, a SUCI recovery procedure;
execute the SUCI recovery procedure with a core network;
obtain, from the core network, a temporary SUCI; and
update one or more parameters associated with the temporary SUCI.

18. The non-transitory computer-readable storage medium of claim 17, wherein the instructions comprise instructions configured to:
transmit to the core network, a registration request that includes an error code associated with a failed attempt to generate the SUCI.

19. The non-transitory computer-readable storage medium of claim 17, wherein the instructions comprise instructions configured to:
select the SUCI recovery procedure based on a stored temporary identifier.

20. The non-transitory computer-readable storage medium of claim 17, wherein the instructions comprise instructions configured to:
attempt, prior to a determination that the SUCI cannot be generated, to generate the SUCI; and
fail to generate the SUCI.
